(19) United States
(12) Patent Application Publication
(10) Pub. No.: US 2024/0191886 A1
(43) Pub. Date: Jun. 13, 2024

(54) ANTIVIBRATION SECUREMENT APPARATUS AND METHOD OF INSTALLING

(71) Applicant: Richard L. Vulliet, Edmonds, WA (US)

(72) Inventor: Richard L. Vulliet, Edmonds, WA (US)

(21) Appl. No.: 18/536,016

(22) Filed: Dec. 11, 2023

Related U.S. Application Data
(60) Provisional application No. 63/431,561, filed on Dec. 9, 2022.

(51) Int. Cl. F24F 1/40; F16F 7/14; F24F 1/60

(52) U.S. Cl. CPC F24F 1/40; F16F 7/14; F24F 1/60; F16F 2224/025; F16F 2228/007

(57) ABSTRACT

An antivibration, mounting apparatus having a screw member to affix the mounting apparatus to a structure, a damper, a threaded fastener member, an equipment attachment member and a fastener member to fasten the equipment attachment member to a piece of equipment.

### BACKGROUND OF THE INVENTION

### Field of the Invention

This invention relates to a device used by contractors, installers, and others involved in the heating, ventilation and air conditioning (HVAC) profession. There is a current trend by cities and municipalities that require installers to secure air conditioners, heat pumps and other equipment to a building or other adjacent, solid structure, to prevent the equipment from blowing over or falling over during a hurricane, earthquake, or other events. Currently it is not codified, but inspectors in some jurisdictions are now requiring securement and the trend is to continue this requirement. The present invention solves this problem by providing a securement system that not only secures the equipment but also minimizes the effects of vibration caused by the equipment.

### Background of the Invention

Hurricane winds, tornadoes and earth quakes can knock an HVAC or other mounted electrical unit off its base, sometimes throwing it and damaging the housing, condenser components, other equipment or structures in the area and worse case, can possibly injure or kill people in the process. For this reason, there are many after-market HVAC tie down kits. These tie-down kits anchor your unit with metal “straps” and bolts directly to a concrete slab. The problem for many residential customers is that it's common in many areas for contractors to rest HVAC units on “concrete colored” foam bases. While the foam is certainly strong enough to support the weight of an HVAC condenser and keep it off the ground, it isn't possible to tie-down a unit by bolting it down into foam. It is possible to strap the equipment to the ground, but as just noted, this is not always easy to do. Sometimes there is nothing to strap to and no way to provide adequate strapping.

In most situations the equipment is located alongside a structure, such as a house, an apartment, an office building, a warehouse or other structure. When adjacent a structure it is possible to secure the equipment to the structure. This provides an alternative option, other than the floor tie down, to stabilize the equipment. Currently there is no commercially available strapping to solve this problem. The current invention provides this solution.

Another issue is that the electrical units typically use a large fan to circulate air through the space to be cooled or heated. These fans create a substantial amount of vibration. This is not an issue when secured to the ground in some manner, but when secured to the structure the vibration communicates along the tie down to the structure, causing sounds, noise, vibration or disturbance to the structure. This vibration can cause damage to the structure and can also be heard and sometimes felt inside the structure by occupants. The current invention also provides a solution to this problem.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

These and other aspects of the invention will be apparent from and elucidated with reference to the embodiment(s) described hereinafter.

### OBJECTS AND SUMMARY OF THE INVENTION

Against the foregoing background, an antivibration securement apparatus for equipment is provided. The mounting apparatus described herein quickly and securely ties equipment to a structure. It is readily available and useable for both commercial and residential applications. It can be used for air conditioners, heat pumps and any other equipment that needs to be secured. These advantages are accomplished using a combination of available parts, all configured in an entirely new way for an entirely new purpose. In a preferred embodiment of the present invention, the system uses parts that are adjustable, securable and yet provide a damping effect to prevent noise and vibration from transferring into the structure.

The accompanying drawings, which are incorporated in and form a part of the specification illustrate preferred embodiments of the present invention, and together with the description, serve to explain the apparatus and principles of the invention.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the inventive subject matter.

FIG. 1 is side view of a prior art strapping and mounting system currently used in the market, utilizing a thin wire to connect the electrical component to the building.

FIG. 2 is another image of a different type of prior art strapping and mounting system currently used in the market.

FIG. 3 is another image of a different type of prior art strapping and mounting system currently used in the market.

FIG. 4 is an elevated view of a first embodiment of the present invention as assembled into one mounting unit.

FIG. 4A is an elevated view of a second embodiment of the present invention as assembled into one mounting unit.

FIG. 5 is an elevated view of the first embodiment of the present invention as assembled and seen from a different angle.

FIG. 6 is an exploded view of the first embodiment of the present invention, showing the separate parts prior to assembly.

FIG. 6A is an exploded view of another embodiment of the present invention, showing the separate parts prior to assembly.

FIG. 7 is another exploded view of the first embodiment of the present invention again showing the separate parts prior to assembly and from a different angle.

FIG. 8 is a perspective view of the first embodiment of the present invention when attached to a large, air conditioning unit at one end and attached to a wooden structure on the other end.

FIG. 9 is another perspective view of the first embodiment of the present invention when attached to a large, air conditioning unit at one end and attached to a brick structure on the other end.

FIG. 10 is another perspective view of the first embodiment of the present invention when attached to a large, elevated and wall hung air conditioning unit at one end and attached to a wooden structure on the other end.

FIG. 11 is yet another perspective view of the first embodiment of the present invention when attached to a large, air conditioning unit at one end and attached to a wooden structure on the other end.

### DETAILED DESCRIPTION OF THE EMBODIMENTS

The disclosed subject matter will become better understood through review of the following detailed description in conjunction with the figures. The detailed description and figures provide example embodiments of the invention described herein. Those skilled in the art will understand that the disclosed examples may be varied, modified, and altered without departing from the scope of the invention described herein.

Throughout the following detailed description, various examples of the antivibration mounting system and embodiments thereof are disclosed. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that example. The reader should understand that a given feature need not be the same or similar to the specific portrayal of a related feature or example.

The invention will now be described in detail with reference to the attached drawings. As described above in the summary, there is a need for antivibration securement apparatus and method of installing, to securely affix and prevent equipment dislodgment, specifically HVAC equipment, and to further insulate and isolate vibration from a structure to which the equipment is affixed.

The FIGS. illustrate a preferred securement system of the present invention. Ideally, the parts are assembled in accordance with the detailed description to follow. However, the parts need not be identical in size, shape or configuration for the apparatus to work properly.

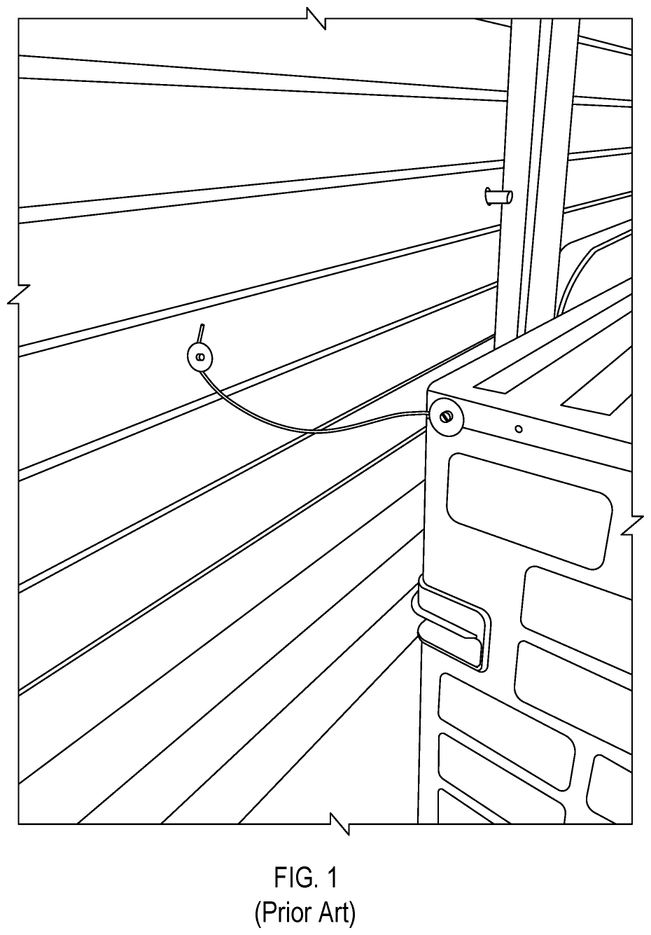

It is becoming more and more common for municipalities and jurisdictions to require securing equipment to an adjacent structure. There currently exist a wide variety of air conditioning and or heating units that stand alongside a housing structure or other structure. These include but are not limited to central air conditioners, splits, portable air conditioners, floor mounted air conditioners, geothermal air conditioning systems, evaporator coolers and hybrid dual fuel air conditioners. When mounted outside, the unit generally sits on a concrete pad or is mounted on supports of some sort to provide a level base. These units are usually rectangular in shape and stand about three to four feet high or taller. The concern is that during high winds or earthquakes the equipment might fall, be pushed or blown over, possibly exposing live electrical wires, exposed electric parts, moving fans, and other hazards and dangers, thus presenting a potentially harmful situation for homeowners, rescuers, emergency medical providers, children, and literally anyone around the equipment. Currently there is no guidance or codification setting forth specific requirements for securement and because there is no agency guidance it has become incumbent on installers to come up with some way to accomplish this task. There currently exist many styles and differing attempts in the industry to solve this problem, as shown in FIGS. 1-3. However, none adequately secure the equipment to the structure, and none provide vibration damping. The present invention addresses and solves the existing problems and provides an apparatus that can easily secure equipment to the structure wall, is easily adjustable to differing installation scenarios, and prevents a variety of different vibrations from affecting the structure and from propagating through the securement apparatus, thus stopping sound and vibration disturbances from affecting the structure.

Installers have attempted a variety of securement solutions that are shown and described next. None of the known securement solutions provide a truly secure attachment and none prevent vibration or the resultant effects of the vibration. FIG. 1 is a prior art type of strapping currently used in the industry. This truly is not a secure way to attach the unit. Here a contractor used a washer, a thin metal line and a couple of screws. The line wraps around the screw at the equipment unit and an attachment screw is screwed into the equipment, clamping the thin metal line between the washer and the equipment unit. The same configuration is used to secure the line to the wall, where the line is wrapped around the screw, the screw is screwed into the wall and the washer captures and holds the thin metal line between the wall and the washer. This system has much to be desired and it is doubtful that it would hold the unit in place if it were to start to tip over. It possibly may prevent the vibration from the equipment from carrying over into the wall because the thin metal line most likely does not transmit the vibration to the structure because it is so thin, but this configuration definitely will not prevent the unit from toppling over.

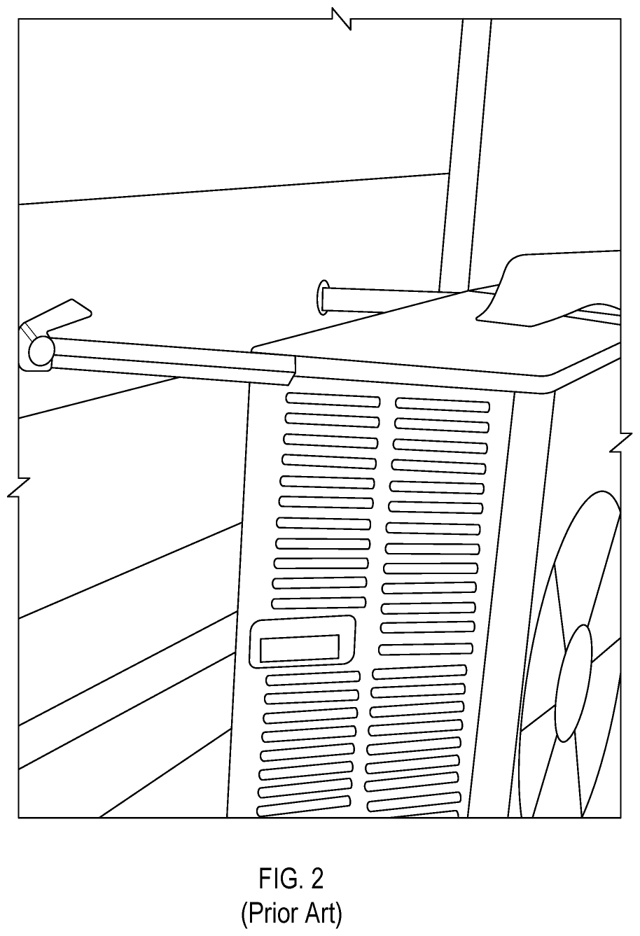

FIG. 2 is another prior art embodiment currently seen in the industry. Here there is a thin metal strap affixed firstly to the equipment unit using a screw or bolt. The thin, metal strap end affixed to the wall is bent and has a piece of foam included between the bracket and the wall in an attempt to stop some of the equipment vibration from affecting the structure. Again, this is not very secure because the metal is thin and easily breakable, the foam does little if anything to prevent vibration and the small screws used to affix to the structure would not provide much protection against the unit falling over. This system is also not adjustable, except for cutting the strapping to length.

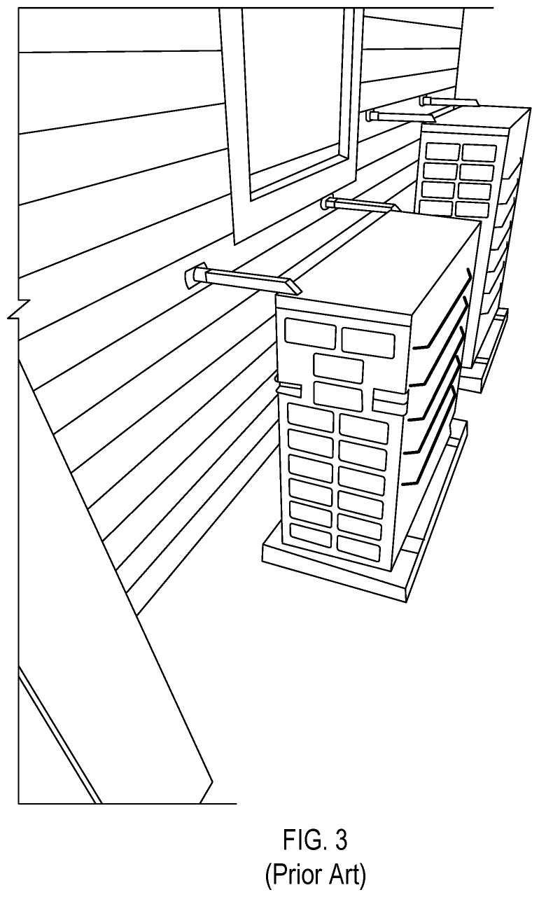

FIG. 3 is another prior art embodiment currently used in the industry that is similar to FIG. 2 but the installer secured the strapping to the top of the equipment unit rather than to the sides of the unit. This configuration is still not secure and does not prevent vibration. Also, it is not easily adjustable.

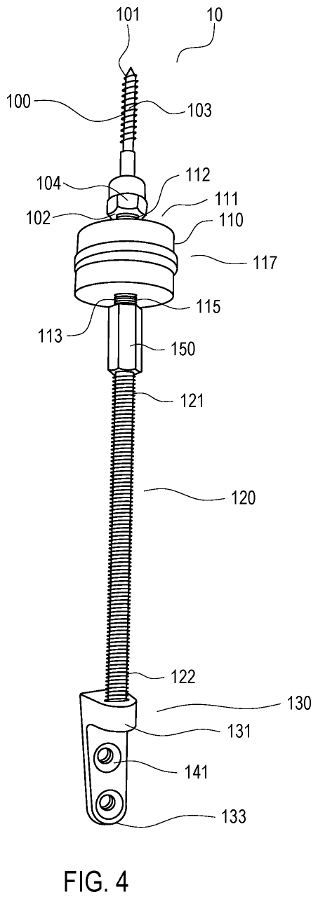

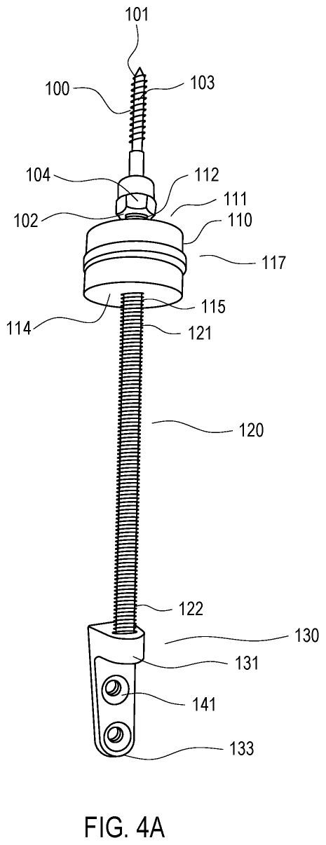

FIGS. 4-7 show a variety of views of the preferred embodiments of the antivibration securement apparatus 10 as assembled and exploded. FIG. 4 shows a first embodiment fully assembled prior to installation and attachment to a structure 20 and equipment. The parts making up the attachment, antivibration securement apparatus 10 are available off the shelf but have never been assembled or used for the current purpose. The parts making up the apparatus are rugged, sturdy, will withstand high winds, a wide range of temperature variations and will easily secure equipment to structures.

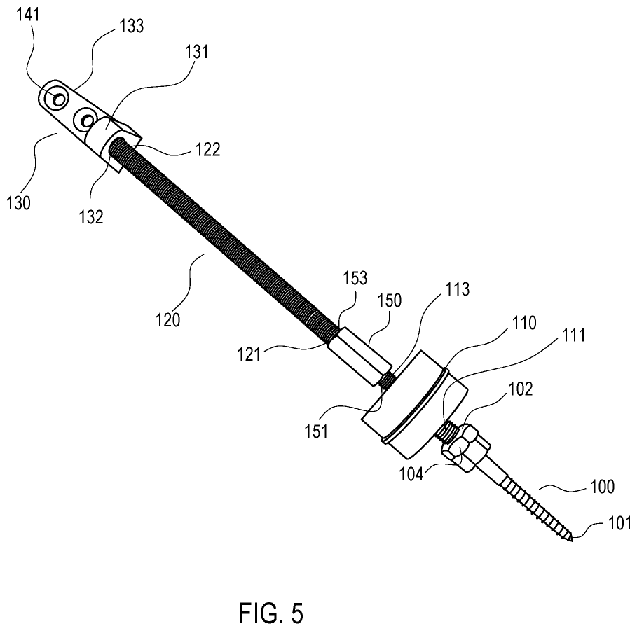

FIG. 5 is another topside view of the current securement apparatus 10 as assembled and as seen from a different angle.

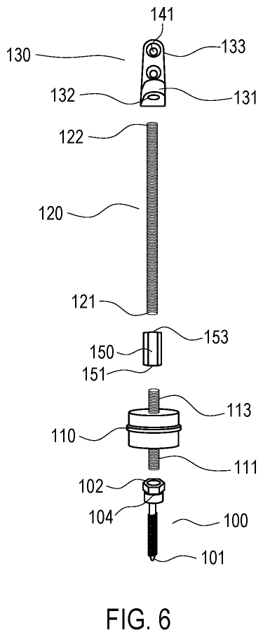

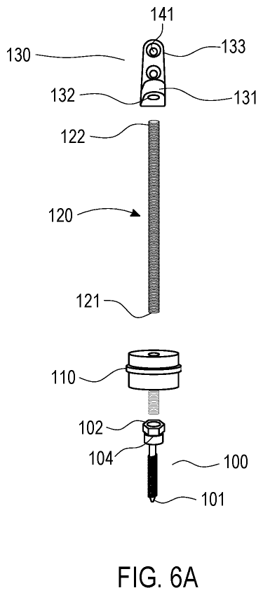

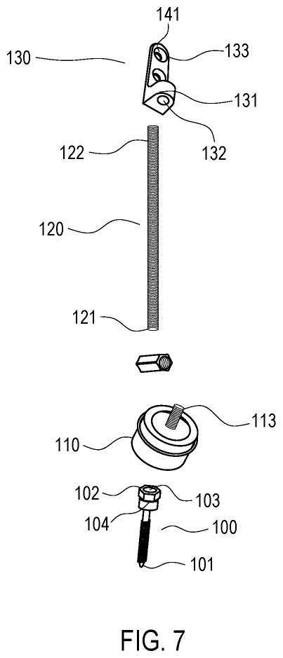

FIG. 6 is an exploded view of the parts of the securement apparatus 10 of the present invention and the separate elements of the invention will now be described in more detail. In its simplest form, the antivibration securement apparatus 10 has a structure attachment member 100, a vibration damper 110, an elongated member 120, an equipment attachment member 130, and at least one fastener 145 to secure the equipment attachment member 130 to an equipment 30. From bottom to top the parts are as follows. At the bottom end, or first end of the securement apparatus 10 is the structure attachment member. In one embodiment this is a screw member 100, commonly known as a rod hanger but because it is not used here to hang rod it will be referred to as screw member 100. A rod hanger is a device typically used to fasten heavy support wires, or rods, to the ceiling or roof structure within a building. The hanger allows installers to quickly and securely install the rods, which are then connected to mechanical and electrical equipment within the ceiling space. The hanger may slide over one end of the rod or may contain threads so the rod can be screwed into place. The screw member 100 used for the present application has threads. The material the screw member 100 is made from should be matched to the application. For example, galvanized or stainless-steel screw member 100 can resist rust and corrosion, while fire-rated hangers should be used to maintain support during a fire emergency. The screw member 100 used in this application is made from steel, but can be made from a variety of other materials. In a preferred embodiment this screw member 100 has a first screw end 101 used to attach the securement apparatus 10 to the structure 20, where the screw is simply screwed into the structure 20. The screw member 100 screw end 101 can be a wood screw, a concrete screw, a metal screw, or any other member for attachment to the structure 20. The screw length is typically about 2 inches but can be longer or shorter depending upon the type of application. The screw member 100 first screw end 101 is generally screwed directly into the structure 20 if it is wood or metal to form a solid connection to the structure 20. The screw member 100 has a second end 102 characterized by a hollow, internally threaded female section 103 with an external hex nut shaped perimeter 104, as can be seen in FIGS. 6, 6A and 7. The internal threading is usually ⅜ but can be any workable dimension. The screw material is generally steel with a zinc climaseal coating and is typically used for installation into wood but can be made from a variety of material and it can have any of a variety of coatings, depending on the circumstances.

Next, a vibration damper member 110 is positioned at and secured to the internal threading 103 at the screw member 100 second end 102. The vibration damper member 110 has a damper 117 that is preferably cylindrical but could be of any shape and configuration. The damper 117 is preferably made from a material having viscoelastic properties, such as hard rubber. This hard rubber member preferably has a shear strength at over 100 pounds-force per square inch. Rubber has a low modulus of elasticity and is capable of sustaining a deformation of as much as 1000 percent. After such deformation, it quickly and forcibly retracts to its original dimensions. It is resilient and yet exhibits internal damping and so is an excellent material for this application. The rubber damper 117 here is in place to counteract the vibration caused by the equipment, whether it be an air conditioner, a heat pump, a furnace unit, fan units, or whatever is being secured to the structure 20. Typically, the equipment uses an electric motor and a blower or fan and these cause substantial vibration and that vibration then travels through the attachment member to the structure 20, causing unwanted vibration and noise. This vibration and noise is noticeable inside the structure 20 and when the structure is a home or living environment this vibration is irritating to the residents. The rubber damper 117 acts to isolate the vibration and prevents the vibration from reaching the structure 20.

In one embodiment, shown in FIG. 4A, the rubber damper member 110 has a first end 111 with a first threaded male connection member 112 extending outwardly from the first end 111; a center member that is the rubber damper 117; and a second end 113, shown in FIG. 5, with second connection member 114 that is a female internally threaded connection member, at the second end 112. The rubber damper first end first threaded connection member 112 as shown in FIG. 4A, is securable to the screw member 100 at the female end where the male threaded end of the first end 111 of the rubber damper member 110 is screwed into the female portion of the screw member 100. The second end is next connectable to the elongated member. In this embodiment, the elongated member is threaded and this threaded end is matingly connectable to the damper second end female member 114, as shown in FIG. 4A. In an alternative embodiment, shown in FIG. 6, the damper member 110 has a first male end 112 and a second male end 115 and instead of the elongated member 120 screwing directly into the damper member 110 it instead screws into the coupling 150. The addition of the coupling 150 allows for greater apparatus adjustability. Ideally all connection members have the same thread configuration so as to simplify useage and installation.

The coupling 150 is typically a nut style, short member with an external hex shape having two opposing internally threaded ends and is used as a connecting member to connect the damper second male end 115 to the elongated threaded fastener member 120. The damper second end 115 is screwed into a first end of the coupling 150 and a second end of the coupling 150 is used to connect to the elongated threaded fastener member 120. This elongated threaded fastener member 120 has a first end 121 and a second end 122 and is used both as an adjusting member and a securement member. This elongated threaded fastener member 120 can be any length and the length is typically determined by the distance from the equipment 30 to the structure 20. The further away the equipment 30 is from the structure 20 the longer the elongated threaded fastener member 120, and conversely, the closer the equipment 30 is to the structure 20 the shorter the elongated threaded fastener member 120.

Next, as shown in FIGS. 4-7, is the equipment attachment member 130. The equipment attachment member 130 acts to securely connect the entire securement apparatus 10 to the equipment. This equipment attachment member 130 can be any of a variety of attachment members that can connect the end of the antivibration securement apparatus 10 to the equipment 30. In the preferred embodiment the equipment attachment member 130 is a pre-threaded attachment fastener configured to easily attach to the elongated threaded fastener member 120. As seen in FIGS. 4-7 the equipment attachment member 130 is preferably an L-shaped member having an attachment member first end 131 that has an internally threaded portion 132 at the bottom of the L that faces the threaded fastener member 120 so that the threaded fastener member 120 is matingly and threadably connectable to the elongated threaded member 120. Preferably, the elongated threaded member 120 is screwed into the equipment attachment threaded member 132 to secure the previously connected parts of the apparatus 10 to the equipment attachment member 130. The L-shaped member has a second end 122 that typically has a portion that provides a way to securely attach the equipment attachment member 130 to the equipment. In the preferred embodiment it is simply one or two holes 141. The number of holes 141 depends on the type of application. These holes 141 are big enough to accept a fastener 145, that can be a screw or bolt or other type of fastener, that is inserted through the hole 141 and that is then screwed into a preformed, threaded hole 146 in the equipment 30. In the preferred embodiment holes are used but it could be any means to attach the apparatus to the equipment. That is, it can be any type of fastener and method of attachment. It is also possible that the side facing the equipment be coated with a vibration absorbing material, or a vibration absorbing material can be inserted between the equipment and the leg of the L-shaped member to further reduce vibration.

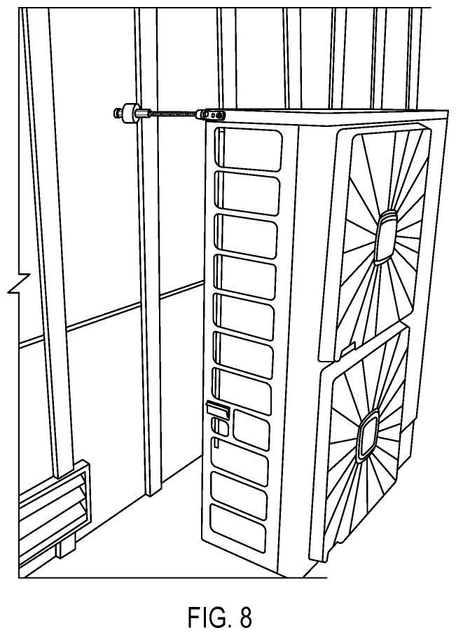

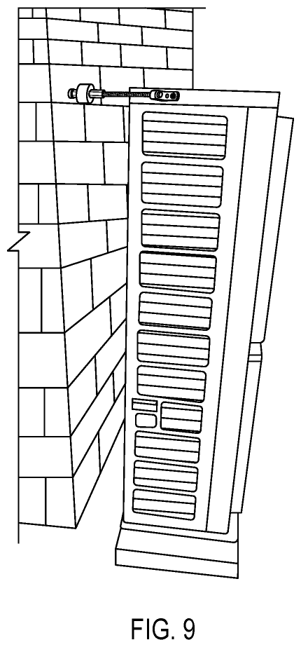

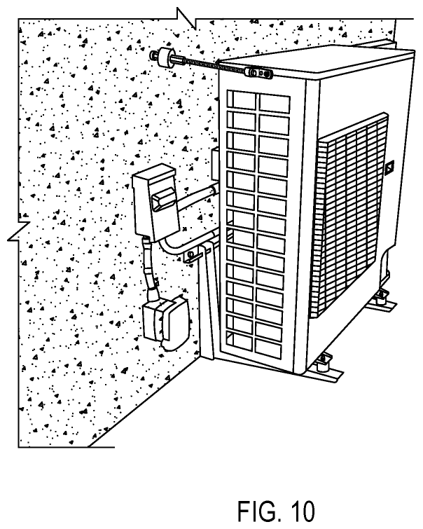

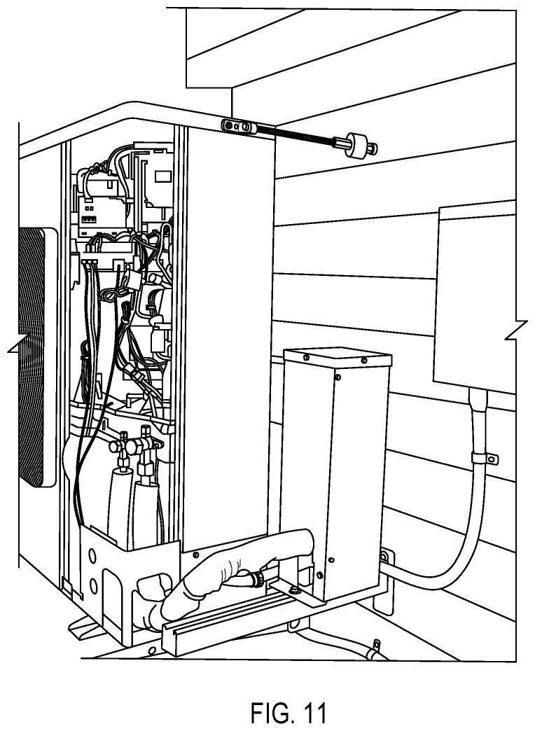

In operation, as seen in FIGS. 8-11, the apparatus 10 easily, cleanly, adjustably and securely attaches and holds the equipment to the structure while simultaneously preventing vibration from propagating through the apparatus and into the structure. In its simplest installation, the method of securing the equipment 30 to the structure 20 using the antivibration securement apparatus 10 has the steps of screwing a first end 101 of a screw member 100 into a location at a structure, affixing a first end 111 of a vibration damper 110 to a second end of the screw member 102, affixing a first end of an elongated member 121 to a second end of the vibration damper 113, affixing an equipment attachment member 130 to a second end of the elongated member 122, and affixing the equipment attachment member 130 to equipment 30. In all the FIGS. the equipment is placed and positioned outside of the structure 30. Once it is properly positioned, a distance from the equipment to the structure is calculated. This calculation is used to determine the length of the elongated fastener member 120. The properly sized elongated fastener member 120 is chosen and installation begins. First, installation begins by attaching the structure attachment member 100 into a side of the structure 20. As mentioned above, the structure attachment member 100, in one embodiment, has a first threaded end 101 and an external hex nut shaped perimeter 104. The structure attachment member 100 screw end 101 is screwed into the structure using a wrench, socket, pliers, or any other tool that can easily use the hex shape perimeter 104 to turn the screw into the structure. Once the screw end 101 is securely affixed to the structure the damper member 110 is installed. In one installation embodiment, taking the damper member 110 an installer aligns the rubber damper first end first threaded male connection member 112 with the screw member female internally threaded portion 103 and insertably screws the male threaded connection member 112 into the screw member female threaded portion 103, thereby securing the damper 110 to the screw member 100.

After connecting the structure attachment member 100 to the structure and to the damper member 110, the elongated member 120 is connected to the damper member 110. In a first embodiment the damper member 110 has the male threaded connection member 112 on one end, a damper 117, and an internally threaded member 114 at the other end. In this embodiment the elongated member 120 is screwed into and securely attached to the damper member 110. Next, the equipment attachment member 130 is put in place. The equipment attachment member 130 in a first embodiment is an L-shaped member. One leg of the L member has an internally threaded portion, typically a threaded hole 132. This portion aligns with and securably affixable to the elongated member 120. In this embodiment the elongated member is externally threaded along the entire length of the member so that L-shaped member is moveable along the entire length of the elongated member 120, thus allowing for a wide range of adjustability for equipment placement and removing the need to have separately sized elongated members. Here, the elongated member 120 is screwed into the hole 132, securing the elongated member to the L-shaped equipment attachment member 130.

Finally, the other leg of the L-shaped equipment attachment member 130 is secured to the equipment. This can be accomplished in a wide variety of ways, but in this embodiment the L-shaped member has at least one hole 146 in the second leg of the L-shaped member. This hole 146 can be either a threaded hole or a through hole. If it is threaded, then matching screws are used to screw through the holes and into matching holes in the equipment. Many of the equipment units have predrilled, threaded holes and these can be used for this purpose. If the holes 146 are just through holes then the screws must only match up with the predrilled, threaded holes in the equipment.

In an alternative embodiment the apparatus further includes a coupling 150 that can secure the damper 110 to the elongated member 120. In this embodiment the damper 110 has two male members, one located at each end of the damper member 110 so that the damper member has a second end second threaded connection member 118. Here, the installer takes coupling 150 and secures it to the rubber damper second end second threaded connection member 118. This is done by taking coupling first end 151 that has an internally threaded portion and fastening it over and to the damper second end second threaded connection member 118, as shown in FIG. 6. Next the installer moves to the coupling second end 152. The coupling second end 152 also has an internally threaded portion. The installer takes the elongated threaded fastener member 120 and secures it to the coupling 150 by aligning the elongated threaded fastener first end 121 with the coupling second end 152 and screwing the elongated threaded fastener first end 121 into the coupling second end 152.

After this is complete the installer connects the equipment attachment member 130. This is accomplished by connecting the equipment attachment member first end 131 to the elongated threaded fastener second end 122. The equipment attachment member first end 131 has the internally threaded member 132 that is matingly securable and fastenable to the elongated threaded fastener second end 122. The threaded fastener second end 122 is screwed into the internally threaded member 132 until the two are securely connected. The last step in connection is affixing the antivibration securement apparatus 10 to the equipment 30. To do this the installer aligns at least one of the equipment attachment member holes 141 with the equipment preformed threaded hole 146. Then, the installer takes the fastener 145, inserts it through the equipment attachment member hole 141 and screws it into the equipment preformed threaded hole 146. Typically, the equipment has a variety of pre-tapped holes around the periphery of the equipment. A bolt or screw that matches the thread configuration of the pre-tapped hole is chosen, is inserted through the equipment attachment member hole 141 and is then screwed into the equipment pre-threaded, pre-formed hole 146. Again, as noted above, it is possible to include an additional vibration damper member between the equipment and the equipment attachment member to further minimize vibration. Finally, the apparatus 10 can be tightened or loosened as required by either screwing the structure attachment member 100 further into the structure or by adjusting the coupling 150. This can be accomplished by leaving the coupling 150 loosely connected to the damper second end second threaded connection member 115 when first connected so that it can later be tightened, and thus shortening the apparatus 10 total length, thus tightening the connection between the equipment 30 and the structure 20. This shortening method can also be employed on the opposite side of the coupling when installing the threaded screw member 100. It can finally be further accomplished in like manner when securing the threaded screw member 100 to the damper second end threaded member 115. As can be seen, the system provides for a variety of ways to adjust the final length of the apparatus 10.

In another embodiment a different type of damper member is employed. In this second embodiment a wire rope isolator 116 is used. Wire rope isolators comprise helical steel cables threaded through high-strength retaining bars. These cable isolators deliver superior shock and vibration protection for sensitive equipment and products. With their durable construction, corrosion resistance and high-temperature tolerance, these isolation solutions are ideal for many applications across a broad industry range. One such isolator has a unique design that makes it an ideal choice for lightweight equipment requiring a high level of shock & vibration isolation. The symmetrically balanced “S” shaped cables give these wire rope isolators a high degree of vertical and horizontal stability (even under large excursions). It is this characteristic that makes this wire vibration isolator vastly superior over similar mounts that have a tendency to collapse or buckle under large motions.

For most applications, however, the preferred damper member is rubber. There are a wide variety of rubbers available for this application and also a wide variety of damper member configurations available. In the preferred embodiment, as described above, the damper member has one tapped hole on the first end and one threaded stud on the second end. In a preferred embodiment an individual vibration damper member has an approximately 10 mm outside diameter, a threaded stud, and a tapped hole. The damper is used to dampen shock loads and reduce noise and wear on the equipment such as motors, conveyors, compressors, fans, or pumps which allows for a safer and more pleasant working and living environment. In this embodiment the dampers also isolate the vibrations and prevent them from propagating through the securement apparatus and into the house or structure. These dampers are often referred to as a sandwich mount or a rubber buffer because they function as a shock or vibration isolator sandwiched between two machine components or surfaces. The rubber jacket is generally made from natural rubber which has good elasticity and is well suited for most industrial equipment. It is preferred that the damper have at least a 30 Shore A harness, but it could be 40 Shore A hardness or more for high dampening and shock absorption. In fact, depending on the application, the Shore A hardness could range from 30 to 80 with a preferred range of 50 to 70 Shore A hardness. The damper bodies are generally made from zinc plated steel allowing for high strength suitability in most industrial applications.

It is known in the industry that HVAC system designers generally evaluate the sounds in the frequencies between 20 and 85 HZ. These frequencies are directly related to (RPS) Revolutions per second of a system compressor. The Shore hardness of the damper is chosen based on the frequency of the system being installed.

Heat pump fan blades have a Frequency, and this frequency creates sound. These frequencies correspond to around 25-50 Hz, with upper harmonics around 60 and 80 Hz. The compressor speed corresponds with a rotation frequency of around 50 Hz and the fan blade's speed upper harmonics are clearly visible in a defrost cycle frequency spectrum. These frequencies are considered when choosing the appropriate hardness for the damper so that the damper may sufficiently mitigate the vibration effects caused by the fan rotation.

FIGS. 8-11 show a variety of applications using the preferred embodiment of the present invention. As can be seen, the system easily connects to the equipment, is easily configurable and adjustable, and cleanly and easily connects to the structure. The system is simple, elegant, clean, adjustable, vibration resistant and secures equipment to structures in a variety of situations and applications.

Although the invention has been described with reference to the preferred embodiments illustrated in the attached drawing figures it is noted that equivalents may be employed and substitutions made herein without departing from the scope of the invention as recited in the claims.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. An antivibration securement apparatus comprising:
a structure attachment member;
a vibration damper;
an elongated member;
an equipment attachment member; and
at least one fastener to secure said equipment attachment member to an equipment.

2. The antivibration securement apparatus of claim 1, where:
said vibration damper is interchangeable with a different vibration damper.

3. The antivibration securement apparatus of claim 2, where:
said vibration damper is rubber.

4. The antivibration securement apparatus of claim 3, where:
said rubber has a Shore hardness of at least 30 and not more than 60.

5. The antivibration securement apparatus of claim 2, where:
said vibration damper is a wire rope isolator.

6. The antivibration securement apparatus of claim 1, where:
said structure attachment member is a wood screw member.

7. The antivibration securement apparatus of claim 1, where:
said structure attachment member is a concrete screw member.

8. The antivibration securement apparatus of claim 1, where:
said elongated member is a threaded member.

9. The antivibration securement apparatus of claim 1, where:
an antivibration member is placed between said equipment attachment member and said equipment.

10. A method of securing equipment to a structure using an antivibration securement apparatus comprising the steps of:
screwing a first end of a screw member into a location at said structure;
affixing a first end of a vibration damper to a second end of said screw member;
affixing a first end of an elongated member to a second end of said vibration damper;
affixing an equipment attachment member to a second end of said elongated member; and
affixing said equipment attachment member to equipment.

11. The method of securing equipment to a structure of claim 10, further including the step of inserting an antivibration member between said equipment attachment member and said equipment.

12. The method of securing equipment to a structure of claim 10, further including the steps of:
having a coupling with a first end, a middle portion and a second end;
affixing said first end of said coupling to said second end of said vibration damper; and
affixing said second end of said coupling to said first end of said threaded member.

13. The method of securing equipment to a structure of claim 10, further comprising the step of inserting a vibration damper between said equipment attachment member and said equipment.
